(19) United States
(12) Patent Application Publication
(10) Pub. No.: US 2009/0050700 A1
(43) Pub. Date: Feb. 26, 2009

(54) Adding and detecting bar code printed with ink invisible to human eye onto printed medium

(76) Inventors: Noboru Kamijoh, Kanagawa-ken (JP); Kazumasa Ochiai, Kanagawa-ken (JP)

Correspondence Address: LAW OFFICES OF MICHAEL DRYJA, 1474 N COOPER RD #105-248, GILBERT, AZ, 85233, US

(21) Appl. No.: 11/845,080

(22) Filed: Aug. 26, 2007

(51) Int. Cl. G06K 7/00; G06K 19/06

(52) U.S. Cl. 235/440; 235/494

(57) ABSTRACT

A bar code is added to a printed medium having one or more images visible to the human eye. The bar code is printed with ink invisible to the human eye. The bar code as printed on the printed medium with ink invisible to the human eye is then detected, such as by a computing device like a mobile phone-type device. Information relating to the images on the printed medium is decoded from the bar code and transmitted to an electronic service. In return, electronically encoded information relating to the images on the printed medium is received from the electronic service and displayed.

### FIELD OF THE INVENTION

The present invention relates generally to printed media having images visible to the human eye, and more particularly to adding and detecting bar codes printed with ink invisible to the human eye on such printed media.

### BACKGROUND OF THE INVENTION

Information is increasingly being provided in a digitized, electronically encoded manner. For example, digital cameras currently outsell traditional film-based cameras. As another example, documents are commonly stored in electronic form, instead of in paper form, for archival and other purposes. However, significant amounts of information are still provided in traditional printed formats. Such information includes that within newspapers, magazines, books, and so on. Furthermore, there is no indication that such printed media will disappear anytime soon.

Tying information provided in traditional printed formats, on printed media, with digital, electronically encoded information has traditionally not been successful. For example, a reader of an article printed in a traditional newspaper may want to have an electronic version of the article. Currently the user either has to type in the article him or herself, or attempt to locate the article on the Internet, where the article may or may not be available for electronic download. For these and other reasons, therefore, there is a need for the present invention.

### SUMMARY OF THE INVENTION

The present invention relates to adding and detecting bar codes printed with ink invisible to the human eye onto printed media. A method of one embodiment of the invention adds a bar code printed with ink invisible to the human eye onto a printed medium that has one or more images visible to the human eye. The bar code encodes information relating to these images, and is scannable by a computing device to transmit the information to an electronic service. In return, the computing device returns digitized, electronically encoded information relating to the images of the printed medium, which can then be displayed to the user.

A method of another embodiment of the invention detects a bar code printed with ink invisible to the human eye onto a printed medium having one or more images visible to the human eye. The method decodes information relating to these images from the bar code after scanning the bar code. This information is transmitted to an electronic service. In return, electronically encoded information relating to the images of the printed medium is received from the electronic service, and displayed to the user.

A computing device of an embodiment of the invention includes at least a capturing mechanism, an extraction mechanism, a communication mechanism, and a display mechanism. The capturing mechanism captures first and second electronic versions of a printed medium on which a bar code has been printed with ink invisible to the human eye and on which one or more images visible to the human eye have been printed. The first electronic version corresponds to at least the images visible to the human eye and the second electronic version corresponds to at least the images visible to the human eye and the bar code invisible to the human eye. The extraction mechanism extracts the bar code from the first electronic version of the printed medium, using both the first and the second electronic versions of the printed medium.

The communication mechanism transmits information relating to the images of the printed medium as decoded from the bar code extracted from the first electronic version of the printed medium. The information is transmitted to an electronic service, from which the communication mechanism receives electronically encoded information relating to the images of the printed medium from the electronic service. The display mechanism displays the electronically encoded information relating to the images of the printed medium to a user of the computing device. The computing device may be a mobile phone-type device having telephony capabilities, or another type of computing device.

Still other aspects and embodiments of the invention will become apparent by reading the detailed description that follows, and by referring to the accompanying drawings.

### BRIEF DESCRIPTION OF THE DRAWINGS

The drawings referenced herein form a part of the specification. Features shown in the drawing are meant as illustrative of only some embodiments of the invention, and not of all embodiments of the invention, unless otherwise explicitly indicated, and implications to the contrary are otherwise not to be made.

FIG. 1 is a diagram of a system in which an invisible bar code printed on a printed medium also including visible images is scanned by a computing device to acquire electronically encoded information regarding the visible images from an electronic service, according to an embodiment of the invention.

FIG. 2 is a flowchart of a method for adding an invisible bar code to a printed medium also including visible images, according to an embodiment of the invention.

FIGS. 3A, 3B, and 3C are diagrams exemplary illustrating where an invisible bar code may be printed on a printed medium also including visible images, according to different embodiments of the invention.

FIG. 4 is a flowchart of a method for detecting (i.e., reading) an invisible bar code printed on a printed medium also including visible images, according to an embodiment of the invention.

FIG. 5 is a diagram of a representative computing device, according to an embodiment of the invention.

FIG. 6 is a flowchart of a method for detecting (i.e., reading) an invisible bar code printed on a printed medium also including visible images, which is performed by a device such as a mobile phone device, according to an embodiment of the invention.

### DETAILED DESCRIPTION OF THE DRAWINGS

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the present invention is defined only by the appended claims.

### Overview

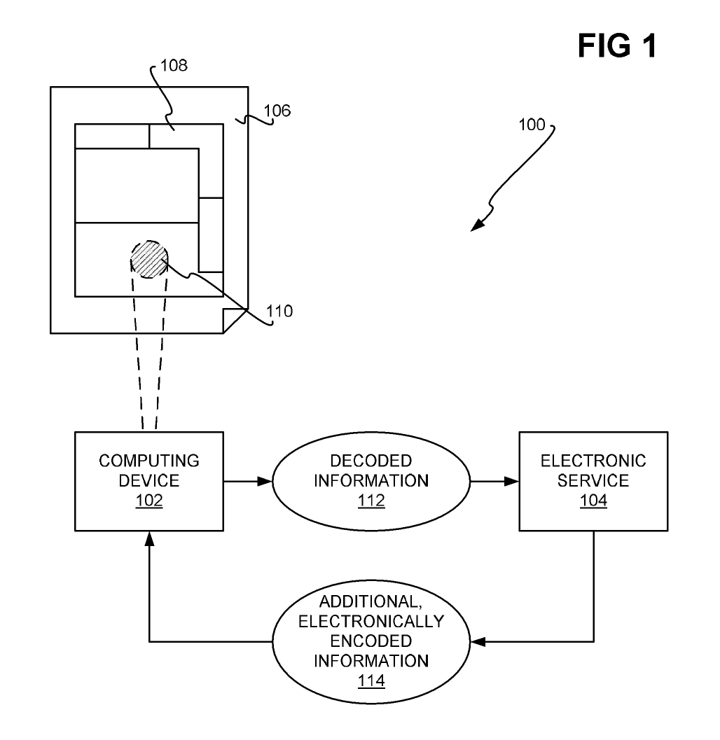

FIG. 1 shows a system 100, according to an embodiment of the invention, in relation to which general operation of an embodiment of the invention is described. The system 100 includes a computing device 102 and an electronic service 104. The computing device 102 may be any type of computing device, such as a mobile phone-type device having telephony capabilities or functionality, a laptop or desktop computer, a personal digital assistant (PDA) device, or another type of computing device. The electronic service 104 may be hosted by a server, such as a web server connected to the Internet.

The computing device 102 and the electronic service 104 are communicatively connected to one another. For instance, they may be communicatively connected to one another over one or more networks. Such networks may include the Internet, intranets, extranets, local-area networks (LAN's), wide-area networks (WAN's), wired networks, wireless networks, land-line telephony networks, mobile telephony networks, and/or other types of networks.

The computing device 102 electronically captures one or more versions of a printed medium 106. The printed medium 106 is a physical medium, such as paper, on which one or more images 108 have been printed. The printed medium 106 may be a page of a book, a page of a magazine, a page of a newspaper, or another type of printed medium. The images 108 may include black-and-white and/or color text and/or graphics. The images 108 are printed such that they are visible to the human eye without assistance This means that the images 108 are able to be viewed by the human eye in regular visible light, without the assistance of ultraviolet light, infrared light, or other light in the non-visible spectrum.

The printed medium 106 also includes a bar code 110 printed thereon. The bar code 110 is printed in invisible ink, which means that the bar code 110 is printed in ink that is not visible to the human eye without assistance. For example, the bar code 110 may be printed in ink that is visible only upon being subjected to ultraviolet light, ink that is visible only upon being subjected to infrared light, and so on. The terminology “bar code” is used herein as a generic and encompassing term that is indicative of any type of code that encodes information. More specifically, the bar code 110 encodes information relating to the images 108. For example, the bar code 110 may encode the universal resource locator (URL) address of the electronic service 104, as well as an identifier that uniquely identifies the images 108 that have been printed on the printed medium 106.

Embodiments of the invention are not limited to the types of bar codes that the bar code 110 may be. The bar code 110 may be a one-dimensional bar code, a two-dimensional bar code, or another type of bar code. For example, the bar code 110 may be a QR bar code, a PDF417 bar code, a DataMatrix bar code, a Maxi Code bar code, or another type of bar code. The QR bar code, the PDF417 bar code, the DataMatrix bar code, and the Maxi Code bar codes are specific types of bar codes that are known within the art, as can be appreciated by those of ordinary skill within the art.

The computing device 102 detects and extracts the bar code 110 printed on the printed medium 106 with invisible ink. The computing device 102 optically scans at least the bar code 110 as printed on the printed medium 106. In one embodiment, the computing device 102 may optically scan two versions of the printed medium 106: one representing at least the visible images 108 on the printed medium 106, in response to subjecting the printed medium 106 with visible light; and another representing at least the visible images 108 and the invisible bar code 110 on the printed medium 106, in response to subjecting the printed medium 106 with additional light having wavelength(s) that are not in the visible light spectrum. Such wavelength(s) of light may be in the ultraviolet spectrum and/or in the infrared spectrum, for instance.

The computing device 102 decodes the information relating to the images 108 that is encoded in the bar code 110, as the decoded information 112. This decoded information 112 relating to the images 108 on the printed medium 106 are transmitted by the computing device 102 to the electronic service 104. In response, the electronic service 104 transmits additional, electronically encoded information 114 relating to the images 108 back to the computing device 102. The computing device 102 can then display this additional, electronically encoded information 114 to the user, for instance.

For example, the images 108 may be an article printed on a magazine page that is the printed medium 106. The bar code 110 may indicate the URL address of the electronic service 104, an identifier that uniquely identifies the article in question, and the cost for downloading an electronic copy of the article. The computing device 102 scans the printed medium 106, and may display to the user that downloading an electronic copy of the article costs a certain amount of money. Alternatively, the printed medium 106 itself may indicate how much downloading an electronic copy of the article costs.

If the user wishes to acquire an electronic copy of the article, he or she may press a button on the computing device 102, which sends the decoded information 112 to the electronic service 104. As such, computing device 102 receives back from the electronic service 104 the electronic copy of the article (as the additional, electronically encoded information 114), for display by the user. The user's account with the electronic service 104 may then be appropriately debited or charged for the user's downloading of the article in question. In this and other ways, embodiments of the invention tie together information on printed media with digitized electronically encoded information.

### Adding Invisible Bar Code to Printed Medium Having Visible Images

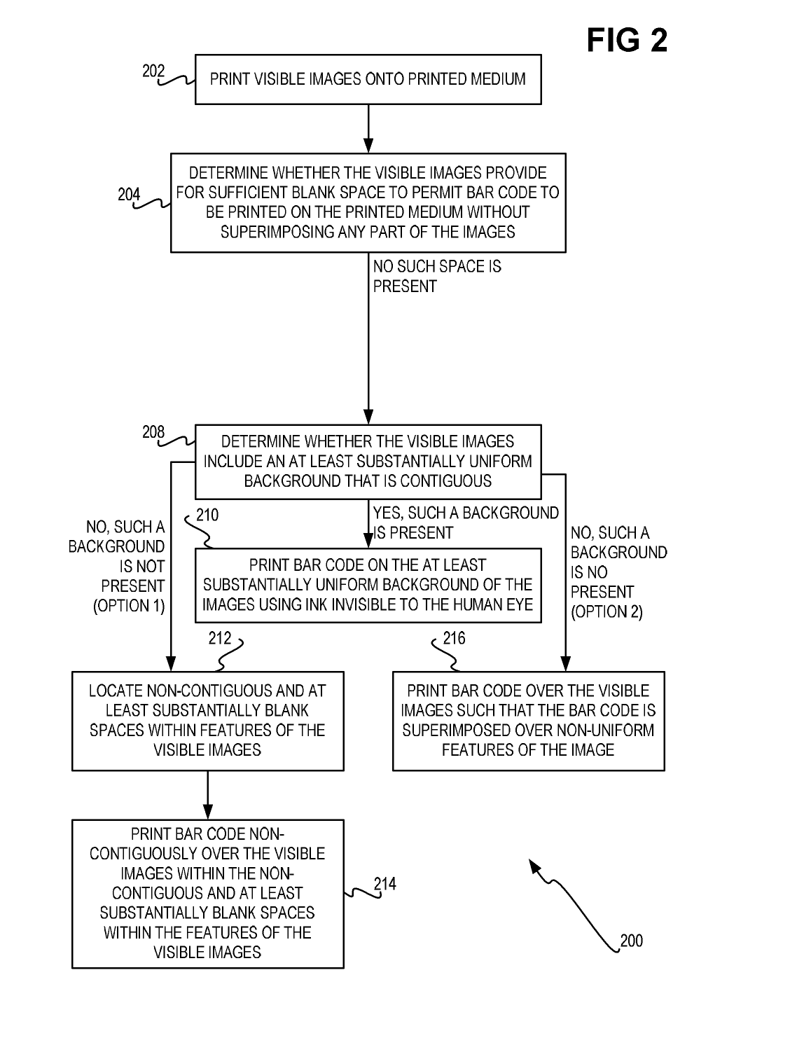

FIG. 2 shows a method 200 for adding the invisible bar code 110 to the printed medium 106, according to an embodiment of the invention. The visible images 108 are printed onto the printed medium 106 (202). The visible images 108 are printed with visible ink, such that they are visible by the human eye without assistance from special light sources, as has been described. While part 202 of the method 200 is depicted in FIG. 2 as being performed before the bar code 110 is printed, in another embodiment the visible images 108 may be printed after the bar code 110 is printed.

The method 200 determines whether the visible images 108 as printed on the printed medium 106 provide for sufficient blank space to permit the invisible bar code 110 to be printed on the printed medium 106 without the bar code 110 superimposing any part of the images 108 (204). For purposes of embodiments of the invention, it is presumed that there is insufficient blank space on the printed medium 106 to print the bar code 110, such that the method 200 determines whether the visible images 108 printed on the printed medium 106 have a contiguous and at least substantially uniform-in-color background on which the bar code 110 can be printed (208). Furthermore, it is noted that the visible images 108 are defined as other than blank space of the printed medium 106 on which no portions of the images are located. That is, the images 108 do not include such blank space.

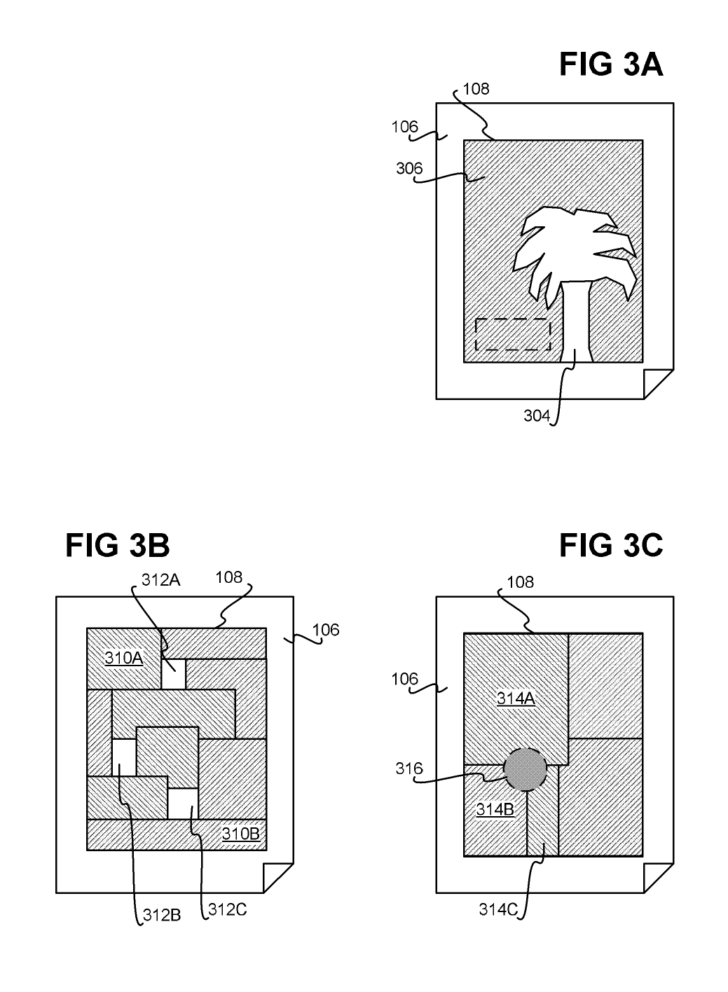

FIG. 3A shows an example of such visible images 108 printed on the printed medium 106, according to an embodiment of the invention. The visible images 108 include a tree 304 of varying colors and intensities against a background 306. The background 306 may be blue in color to represent the sky, and may be the same color blue and the same intensity of blue throughout. The background 306 is sufficiently contiguous to permit the entire bar code 110 to be printed within the area 308.

Thus, where such a contiguous and sufficiently uniform background within the visible images 108 printed on the printed medium 106 is present, the method 200 prints the bar code 110 within this background (210). The bar code 110 is printed using ink that is invisible to the human eye, as has been described. It is said that the bar code 110 is superimposed on the at least substantially uniform-in-color background of the visible images 108 in that it is printed on a portion of this background.

It is noted that the terminology background as used herein is meant in a general sense, such that a substantially uniform-in-color background of the visible images 108 encompasses any portion of the images 108 that is substantially uniform in color. For example, in relation to FIG. 3A, if the tree 304 were sufficiently large and substantially uniform in color, it could serve as the background on which the bar code 110 is printed. That is, the terminology background is used in the sense that it is that portion of the images 108 on which the bar code 110 is printed in part 208 of the method 200.

However, where the visible images 108 lack a sufficient contiguous and at least substantially uniform in color background on which to print the invisible bar code 110, the method 200 proceeds to one of two options. First, the method 200 may locate non-contiguous and at least substantially blank spaces within the features of the visible images 108 over which to print separate parts of the bar code 110 (212). FIG. 3B shows an example of such non-contiguous and at least substantially blank spaces within the features of the visible images 108 printed on the printed medium 106, according to an embodiment of the invention.

The visible images 108 include such features as the particularly called out features 310A and 310B, collectively referred to as the features 310, in FIG. 3B. There are non-contiguous and at least substantially blank spaces 312A, 312B, and 312C, collectively referred to as the blank spaces 312, within the features of the visible images 108 in FIG. 3B. As another example, not illustrated in the drawings, the blank spaces between adjacent letters in words printed on the printed medium 106, and the blank spaces between adjacent words in text printed on the printed medium 106, can be the blank spaces in question.

The invisible bar code 110 is then printed non-contiguously over the visible images 108, within the non-contiguous and at least substantially blank spaces within the features of the visible images of the printed media 106 (214). Thus, the bar code 110 is split into different parts corresponding in size and/or in number to the non-contiguous blank spaces that are present. Each part is printed on one of these non-contiguous blank spaces. As before, the bar code 110 is printed with invisible ink, as has been described, such that the bar code 110 is invisible to the human eye.

The second option that may be employed, in lieu of performing parts 212 and 214, is for the method 200 to simply print the invisible bar code 110 contiguously over the visible images 108 of the printed media 106 (216). As such, the invisible bar code 110 is superimposed over and overlaps with non-uniform features of the visible images 108. FIG. 3C shows an example of printing the invisible bar code 110 over features of the visible images 108, according to an embodiment of the invention. The features of the visible images 108 include non-uniform in color and/or in intensity features 314A, 314B, and 314C, collectively referred to as the features 314. The invisible bar code 110 may be printed on the area 316, which overlaps with and superimposes the features 314.

As another example, not illustrated in the drawings, the invisible bar code 110 may be printed contiguously such that it overlaps successive letters, words, and/or lines of text printed on the printed medium 106.

Detecting Invisible Bar Code from Printed Medium Having Visible Images

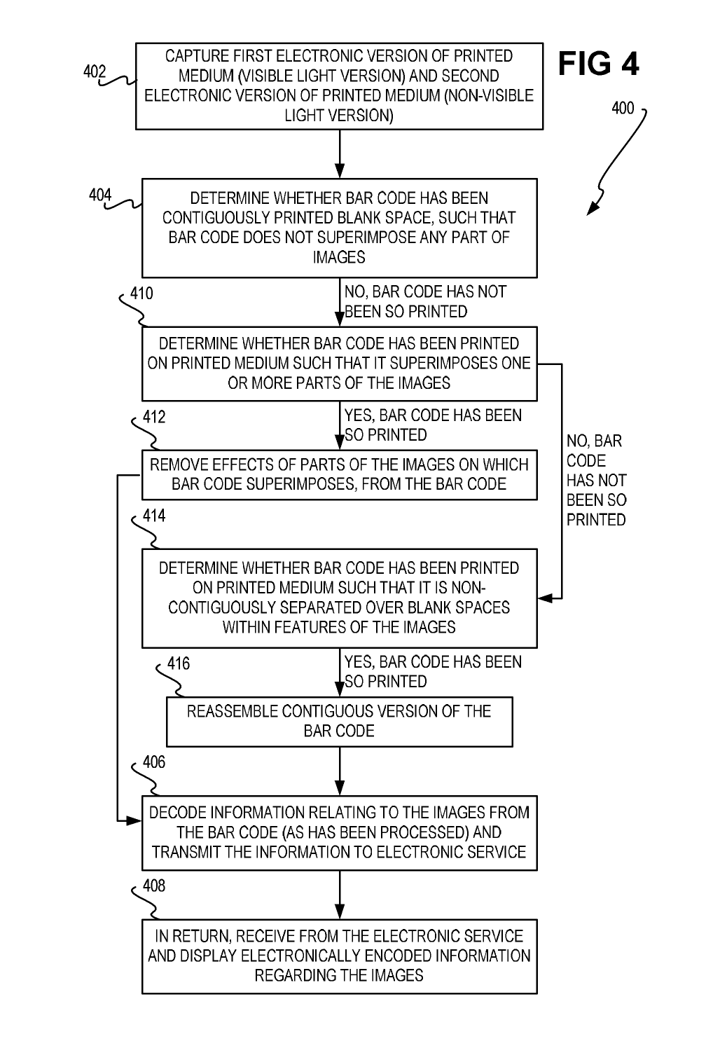

FIG. 4 shows a method 400 for detecting (i.e., reading) the invisible bar code 110 as printed on the printed medium 106 that also includes the visible images 108, according to an embodiment of the invention. Two electronic versions of the printed medium 106, including the invisible bar code 110 and the visible images 108 printed thereon, are optically captured (402). The first electronic version is a visible light version, corresponding to at least the images 108 visible to the human eye. The second electronic version is a visible light version combined a non-visible light version, such as an additional infrared light version or an ultraviolet light version, corresponding to at least the visible images 108 and the invisible bar code 110 that is invisible to the human eye. These two versions may be captured back-to-back within a short period of time via synchronized visible light and non-visible (i.e., infrared or ultraviolet) light.

With respect to the first electronic version, white light, or red, green, and blue light in succession, may be emitted onto the printed medium 106, and the reflected light detected in a pixel-by-pixel manner, to effectively scan a visible light representation of the printed medium 106. Alternatively, ambient (i.e., environmental) lighting may be considered as implicating providing such white light in one embodiment to scan the visible light representation of the printed medium 106. For color images in particular, such a visible light representation of the printed medium 106 (i.e., the first electronic version) can include a red light representation, a green light representation, and a blue light representation of the printed medium 106. As can be appreciated by those of ordinary skill within the art, such optical scanning may not remove all crosstalk between the invisible bar code 110 and the visible images 108, even though the invisible bar code 110 is at least substantially invisible to the visible spectrum of light (including red, green, and blue light). As such, some artifacts from the invisible bar code 110 may be present within the first electronic version of the printed medium 106.

With respect to the second electronic version, ultraviolet or infrared light may be additionally emitted onto the printed medium 106, and the reflected light detected in a pixel-by-pixel manner, to effectively scan a non-visible light (e.g., ultraviolet light or infrared light) representation of the printed medium 106. As can also be appreciated by those of ordinary skill within the art, such optical scanning may not remove all crosstalk between the invisible bar code 110 and the visible images 108. As such, some artifacts from the visible images 108 may be present within the second electronic version of the printed medium 106. It is noted that the first and the second electronic versions are employed for performing at least parts 404, 410, 412, 414, and 416 of the method 400, as these parts will be described, and as can be appreciated by those of ordinary skill within the art.

The method 400 next determines whether the invisible bar code 110 has been contiguously printed on (sufficient) blank space on the printed medium 106, such that the bar code 110 does not superimpose any parts of the visible images 108 of the printed medium 106 (404). It is presumed for purposes of embodiments of the invention that the invisible bar code 110 is determined to have not been printed within a contiguous blank space on the printed medium 106. As such, the method 400 determines whether the bar code 110 instead has been printed on the printed medium 106 such that it superimposes one or more parts of the visible images 108 (410).

This type of printing corresponds to the situation that has been described in relation to FIG. 3A, or the situation that has been described in relation to FIG. 3B. In the former situation, the method 400 determines that the invisible bar code 110 has been printed on an at least substantially uniform background of the visible images 108, which can again be achieved by digital signal processing of the first and second electronics versions of the printed medium 106. For example, if substantially all the pixels within the second electronic version that have non-zero values correspond to pixels within the first electronic version that have the same non-white (i.e., substantially uniform) values, then it can be concluded that the invisible bar code 110 that encompasses these pixels within the second electronic version was printed on a substantially uniform background of the images 108.

In the latter situation, by comparison, the method 400 determines that the invisible bar code 110 has been printed over the visible images 108 such that the bar code 110 is superimposed over non-uniform features of the images 108. This can also be achieved by digital signal processing of the first and second electronic versions of the printed medium 106. For example, if substantially all the pixels within the second electronic version that have non-zero values correspond to pixels within the first electronic version that have different values, then it can be concluded that the invisible bar code 110 that encompasses these pixels within the second electronic version was printed over the images 108 such that it overlaps non-uniform (in color and/or in intensity) features of the visible images 108.

If the invisible bar code 110 is determined to have been printed on the printed medium 106 in either of these manners, then the method 400 removes the effects in question from the bar code 110 (412). In the situation that has been described in relation to FIG. 3A, for instance, any effects of the substantially uniform background present within the second electronic version of the printed medium 106 are removed from the bar code 110 within this second electronic version. For instance, digital signal processing can be employed, as can be appreciated by those of ordinary skill within the art. In effect, a baseline value of the substantially uniform background within the second electronic version—where there is no part of the invisible bar code 110—is removed from each pixel of the invisible bar code 110 within this second electronic version.

Similarly, in the situation that has been described in relation to FIG. 3B, any effects of the non-uniform features of the images 108 present within the second electronic version of the printed medium 106 are removed from the bar code 110 within this second electronic version. As can be appreciated by those of ordinary skill within the art, digital signal processing can be employed. For instance, a baseline value of blank (i.e., empty) parts of the printed medium 106, as detected within the first electronic version, can be employed to determine which parts of the printed medium 106 correspond to features of the images 108. Thereafter, the parts of the printed medium 106 corresponding to such features of the images 108 can be removed from corresponding pixels of the invisible bar code 110 within this second electronic version.

Once the effects of the parts of the visible images 108 that the invisible bar code 110 overlaps or superimposes have been removed from the bar code 110, the bar code is decoded to yield information that is transmitted to the electronic service 104 (406). The information is decoded from the bar code in part 406 in relation to the bar code as has been processed to remove the parts of the visible images 108 that the bar code 110 overlaps or superimposes. The electronically encoded information received in response from the electronic service 104 is then displayed (408).

If the invisible bar code 110 is determined to have not been printed as overlapping or superimposing one or more parts of the visible images 108, the method 400 determines determine the bar code 110 instead has been printed on the printed medium 106 such that it is non-contiguously separated over blank spaces within features of the images 108 (414). This type of printing corresponds to the situation that has been described in relation to FIG. 3C. Thus, in this situation, the method 400 reassembles a contiguous version of the invisible bar code 110 from its non-contiguous parts (416). As can be appreciated by those of ordinary skill within the art, digital signal processing can be employed to achieve such reassembly.

For example, those pixels within the second electronic version of the printed medium 106 that have non-zero values may be determined as corresponding to these non-contiguous parts of the invisible bar code 110. As such, the zero values in between may be spatially removed to result in a contiguous version of the invisible bar code 110. Thereafter, as before, the information relating to the visible images 108 is decoded from the (reassembled) bar code 110 and transmitted to the electronic service 104 (406). The additional electronically encoded information received in return from the electronic service 104 is then displayed (408).

### Representative Computing Device

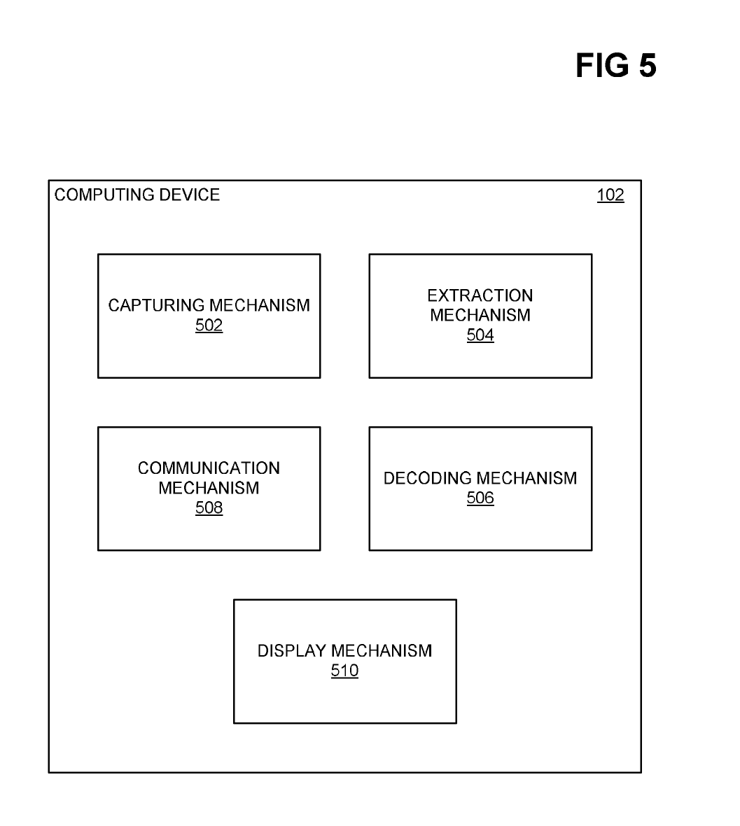

FIG. 5 shows a block diagram of a representative computing device 102, according to an embodiment of the invention. The computing device 102 is depicted in FIG. 5 as including a capturing mechanism 502, an extraction mechanism 504, a decoding mechanism 506, a communication mechanism 508, and a display mechanism 510. Each of the mechanisms 502, 504, 506, 508, and 510 may be implemented in software, hardware, or a combination of software and hardware. The computing device 102 can and typically does include other components, in addition to and/or in lieu of those depicted in FIG. 5, such as processors, memory, and so on.

The capturing mechanism 502 optically captures two electronic versions of the printed medium 106 as has been described: a visible light version and an additional non-visible light version. The capturing mechanism 502 may thus include one or more visible light sources, such as a white light source or red, green, and blue light sources, and one or more non-visible light sources, such as an ultraviolet light source and/or an infrared light source. The capturing mechanism 502 may further include one or more light sensors, to detect the light output by the light sources as reflected by the printed medium 106.

The extraction mechanism 504 extracts the bar code 110 from the electronic versions of the printed medium 106, as has been described. The extraction mechanism 504 may include software running on a processor, or may be implemented in a dedicated semiconductor, such as an application-specific integrated circuit (ASIC). The decoding mechanism 506 decodes the information relating to the images 108 as encoded in the bar code 110. The decoding mechanism 506 may also include software running on a processor, or may be implemented in a dedicated semiconductor, such as an ASIC.

The communication mechanism 508 transmits the information relating to the images 108 as decoded from the bar code 110 to an electronic service 104. The communication mechanism 508 also in response receives from the electronic service 104 additional, electronically encoded information relating to the images 108 on the printed medium 106. The communication mechanism 508 may include a transceiver, an antenna, and so on, for communication over one or more networks as has been described above. Finally, the display mechanism 510 displays the additional, electronically encoded information relating to the images 108 that has been received by the communication mechanism 508. The display mechanism 510 may be a display device, such as a flat-panel display device like a liquid crystal display (LCD), or another type of flat-panel display device, or another type of display device altogether.

### Particular Method and Conclusion

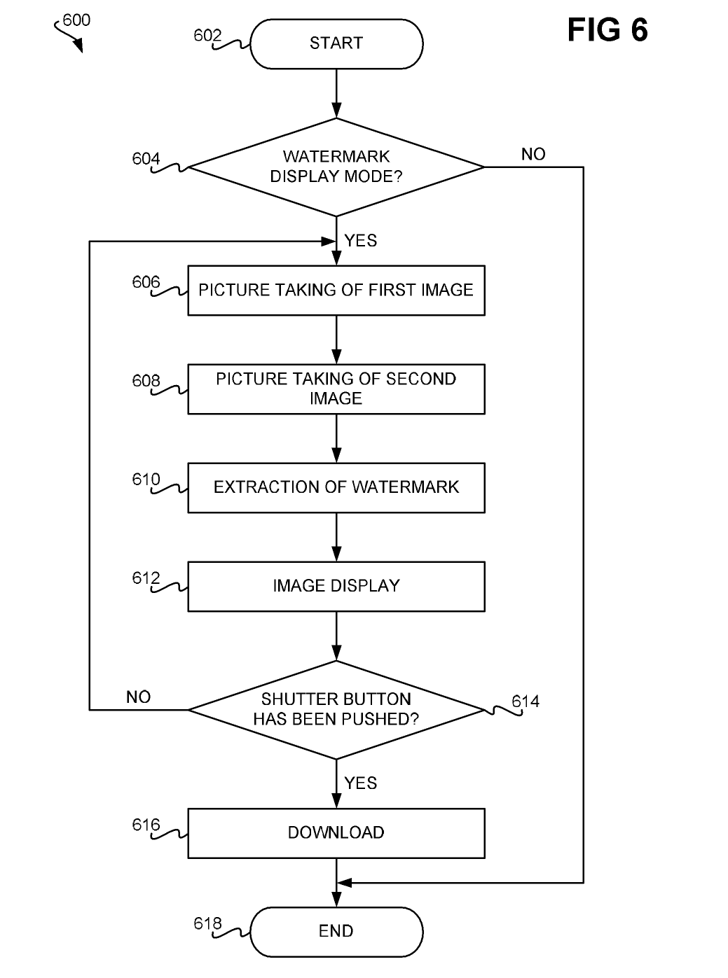

FIG. 6 shows a method 600 that can be employed to detect an invisible bar code printed on a printed medium also including visible images, according to an embodiment of the invention. The method 600 may be employed by a mobile phone device, such as a cell phone, that includes picture-taking capability. After starting (602), the method 600 determines whether the device in question is operating in a watermark display mode (604). The watermark display mode is one in which an invisible bar code is to be detected. If the device is not currently operating in this mode, then the method 600 is finished (618).

Otherwise, a picture of a first image of the printed medium is taken (606). The picture of the first image corresponds to just the visible image printed on the printed medium. This first image may be taken by employing ambient light (i.e., environmental light), or by using a flash capability of the device in question. A picture of a second image of the printed medium is also taken (608). The picture of the second image corresponds to both the visible image printed on the printed medium, as well as the non-visible bar code printed on the printed medium. This second image may be taken by emitting non-visible light of the type in which the non-visible bar code has been printed on the printed medium. Such non-visible light may be ultraviolet light, for instance, or infrared light. The non-visible light may be emitted by employing one or more light-emitting diodes (LED's) of the appropriate type.

In one embodiment, the second image has its picture taken a short period of time after the first image has its picture taken, such as less than 0.5 seconds. This substantially ensures that the printed medium and the device performing the method 600 have not moved between the pictures of the images being taken. As such, the picture of the first image and the picture of the second image are substantially identical from a locational perspective.

The watermark—that is, the invisible bar code—is then extracted (610). As an example, differences in the pixel values between individual pixels of the first image and corresponding pixels of the second image may be determined. Where the difference for a corresponding pair of pixels between the first and the second images is greater than a predetermined reference value, then it is presumed that this difference corresponds to a part of the invisible bar code.

The method 600 then displays the picture of the first image, and superimposes and displays on this first image information based on the invisible bar code that has been extracted (612). The information may be displayed at or near a location on the first image where the bar code has been detected (and decoded) within the second image. If the bar code is not able to be decoded, then what may be displayed alternatively is just the location where the bar code has been extracted.

If the user of the device performing the method 600 has selected the bar code information, by for instance pushing the shutter button on the device (614), then the device downloads a file or other information identified by the bar code (616). Because the user may be charged for downloading this information, the user may have an opportunity to confirm whether he or she wants to download the information prior to the information actually being downloaded. The method 600 is then finished (618). If the user has not selected the bar code information yet (614), however, then the method 600 is repeated at part 606. This permits the bar code information to be displayed in relation time, so that the user is able to locate the bar code easily.

It is noted that, although specific embodiments have been illustrated and described herein, it will be appreciated by those of ordinary skill in the art that any arrangement calculated to achieve the same purpose may be substituted for the specific embodiments shown. This application is thus intended to cover any adaptations or variations of embodiments of the present invention. Therefore, it is manifestly intended that this invention be limited only by the claims and equivalents thereof.

We claim:

1. A method for adding a bar code printed with ink invisible to a human eye onto a printed medium having one or more images visible to the human eye, comprising:
determining whether the images of the printed medium include an at least substantially uniform background in terms of color the at least substantially uniform background being contiguous, where the images are defined as other than blank space of the printed medium on which no portions of the images are located; and,
in response to determining that the images of the printed medium include the at least substantially uniform background in terms of color,
printing the bar code on the at least substantially uniform background of the images of the printed medium using the ink invisible to the human eye, such that the bar code is superimposed on the at least substantially uniform background of the images
wherein the bar code encodes information relating to the images of the printed medium, and is scannable by a computing device to transmit the information to an electronic service such that the electronic service returns electronically encoded information relating to the images of the printed medium in return.

2. The method of claim 1, further comprising:
in response to determining that the images of the printed medium do not include the at least substantially uniform background in terms of color,
printing the bar code over the images of the printed medium using the ink invisible to the human eye, such that the bar code is superimposed over non-uniform features of the images.

3. The method of claim 1, further comprising:
in response to determining that the images of the printed medium do not include the at least substantially uniform background in terms of color,
locating non-contiguous and at least substantially blank spaces within features of the images; and,
printing the bar code non-contiguously over the images of the printed medium using the ink invisible to the human eye, such that the bar code is superimposed on the non-contiguous and at least substantially blank spaces within the features of the images, and is not superimposed on the features of the images themselves.

4. The method of claim 1, further comprising printing the images visible to the human eye on a physical medium to yield the printed medium, where the images visible to the human eye comprise one or more of: black-and-white graphics, black-and-white photos, black-and-white text, color graphics, color photos, and color text.

5. The method of claim 1, wherein the bar code is a QR code.

6. The method of claim 1, wherein the ink invisible to the human eye is one of ink visible at least substantially only in an infrared spectrum and ink visible at least substantially only in an ultraviolet spectrum.

7. A method for detecting a bar code printed with ink invisible to a human eye onto a printed medium having one or more images visible to the human eye, comprising:
capturing a first electronic version of the printed medium, the first electronic version corresponding to at least the images visible to the human eye;
capturing a second electronic version of the printed medium, the second electronic version corresponding to at least the images visible to the human eye and the bar code invisible to the human eye;
in response to determining that the bar code is superimposed over one or more parts of the images;
removing effects of the images as captured within the second electronic version of the printed medium, from the bar code as captured within the second electronic version of the printed medium, using the first electronic version of the printed medium;
decoding information relating to the images of the printed medium from the bar code as captured within the second electronic version of the printed medium and as from which the effects of the images as captured within the second electronic version of the printed medium have been removed;
transmitting the information to the electronic service;
receiving from the electronic service electronically encoded information relating to the images of the printed medium, in return; and,
displaying the electronically encoded information to a user.

8. The method of claim 7, further comprising,
determining whether the bar code has been printed on an at least substantially uniform background of the images, in terms of color, based on the first and the second electronic versions of the printed medium;
in response to determining that the bar code has been printed on the at least substantially uniform background of the images, in terms of color,
removing effects of the at least substantially uniform background of the images as captured within the second electronic version of the printed medium, from the bar code as captured within the second electronic version of the printed medium, using the first electronic version of the printed medium;
decoding information relating to the images of the printed medium from the bar code as captured within the second electronic version of the printed medium and as from which the effects of the at least substantially uniform background of the image as captured within the second electronic version of the printed medium have been removed;
transmitting the information to the electronic service;
receiving from the electronic service electronically encoded information relating to the images of the printed medium, in return; and,
displaying the electronically encoded information to a user.

9. The method of claim 7, further comprising,
determining whether the bar code has been printed over the images of the printed medium such that the bar code is superimposed over non-uniform features of the images, based on the first and the second electronic versions of the printed medium;
in response to determining that the bar code has been printed over the images of the printed medium such that the bar code is superimposed over non-uniform features of the images,
removing effects of the non-uniform features of the images as captured within the second electronic version of the printed medium, from the bar code as captured within the second electronic version of the printed medium, using the first electronic version of the printed medium;
decoding information relating to the images of the printed medium from the bar code as captured within the second electronic version of the printed medium and as from which the effects of the non-uniform features of the image as captured within the second electronic version of the printed medium have been removed;
transmitting the information to the electronic service;
receiving from the electronic service electronically encoded information relating to the images of the printed medium, in return; and,
displaying the electronically encoded information to a user.

10. The method of claim 7, further comprising,
determining whether the bar code has been printed over the images of the printed medium such that the bar code is superimposed on non-contiguous and at least substantially blank spaces within features of the images and is not superimposed on the features of the images themselves, based on the first and the second electronic versions of the printed medium;
in response to determining that the bar code has been printed over the images of the printed medium such that the bar code is superimposed on non-contiguous and at least substantially blank spaces within features of the images and is not superimposed on the features of the images themselves,
reassembling a contiguous version of the bar code from non-contiguous portions of the bar code captured within the second electronic version of the printed medium;
decoding information relating to the images of the printed medium from the contiguous version of the bar code as reassembled from the non-contiguous portions captured within the second electronic version of the printed medium;
transmitting the information to the electronic service;
receiving from the electronic service electronically encoded information relating to the images of the printed medium, in return; and,
displaying the electronically encoded information to a user.

11. The method of claim 7, where the images visible to the human eye comprise one or more of: black-and-white graphics, black-and-white photos, black-and-white text, color graphics, color photos, and color text.

12. The method of claim 7, wherein the bar code is a QR code.

13. The method of claim 7, wherein the ink invisible to the human eye is one of ink visible at least substantially only in an infrared spectrum and ink visible at least substantially only in an ultraviolet spectrum.

14. A computing device comprising:
a capturing mechanism to capture a first electronic version and a second electronic version of a printed medium on which a bar code has been printed with ink invisible to a human eye and on which one or more images visible to the human eye have been printed, the first electronic version corresponding to at least the images visible to the human eye and the second electronic version corresponding to at least the images visible to the human eye and the bar code invisible to the human eye;
an extraction mechanism to extract the bar code using the first and the second electronic versions of the printed medium;
a communication mechanism to transmit information relating to the images of the printed medium as decoded from the bar code extracted from the first electronic version of the printed medium, the information transmitted to an electronic service, the communication mechanism also to receive electronically encoded information relating to the images of the printed medium from the electronic service in return; and,
a display mechanism to display the electronically encoded information relating to the images of the printed medium.

15. The computing device of claim 14, further comprising a decoding mechanism to decode the information relating to the images of the printed medium from the bar code extracted from the first electronic version of the printed medium.

16. The computing device of claim 14, wherein the computing device is a mobile phone-type computing device having telephony capabilities.

17. The computing device of claim 14, where the images visible to the human eye comprise one or more of: black-and-white graphics, black-and-white photos, black-and-white text, color graphics, color photos, and color text.

18. The computing device of claim 14, wherein the bar code is a QR code.

19. The computing device of claim 14, wherein the ink invisible to the human eye is one of ink visible at least substantially only in an infrared spectrum and ink visible at least substantially only in an ultraviolet spectrum.
